(19) United States
(12) Patent Application Publication
(10) Pub. No.: US 2009/0099915 A1
(43) Pub. Date: Apr. 16, 2009

(54) SYSTEMS AND METHODS FOR STANDARDIZED BILLING FOR AT-PREMISE RENEWABLE POWER SYSTEMS

(76) Inventor: Michael Herzig, Cold Spring, NY (US)

Correspondence Address: MEREDITH & KEYHANI, PLLC, 330 MADISON AVE., 6TH FLOOR, NEW YORK, NY, 10017, US

(21) Appl. No.: 11/872,911

(22) Filed: Oct. 16, 2007

(51) Int. Cl. G06Q 30/00

(52) U.S. Cl. 705/14; 705/34

(57) ABSTRACT

A computer implemented method of enabling standardized billing for an at-premise renewable Power System as it is generated at a consumer's premises comprising: providing at least one Power System to a consumer; at least one Calendar having at least one Period, each Period having at least one Segment; providing at least one consumer variable associated with the consumer; assigning a Calendar to the consumer; assigning at least one Rate and at least one characteristic to each Segment; determining the power generated by Power System for the Segment to provide the power generated; determining the usage for the Segment to provide usage; determining a Segment Charge on an ongoing basis according to the consumer's power generated, the usage, the customer variables, the Rate and the at least one characteristic to provide a Segment Charge and summing the Segment Charges to provide a consumer bill.

The present invention relates to systems and methods for enabling standardized billing for distributed at premise renewable power systems.

Many different types of panels and/or systems provide the ability to generate energy from solar power; however, many consumers find the initial payout to be prohibitive. This is because the up-front cost of solar panels/systems is higher in terms of fixed components than other sources of energy. For example, photovoltaic panels (which generate electricity directly from sunlight) are very expensive since they usually require microchip grade silicon. Therefore, the cost of panels for an average house may run from $15,000 to $35,000 (or more), not including what are often substantial installation fees. Solar Hot Water systems tend to be somewhat less expensive, but still run from $5,000 to $10,000 not including installation. These costs must then be compared to competing sources of power. The competing system for photovoltaic panels is connecting to the local grid. This is usually included in the base price of the house, and therefore is considered to be negligible for most consumers. Solar Hot Water heaters compete with gas/oil/electric heater and heat pumps. These are all lower priced than the Solar Hot Water systems by a factor of two or three (or more), which is critical since they are generally installed by a developer who does not benefit from the ongoing cost savings of solar power. Also, replacement usually occurs when a system breaks, and therefore the goal is a quick replacement instead of a long term investment.

Because of these cost considerations, solar panels/systems are not currently as widely used by consumers as they might otherwise be. Nonetheless, these systems have the following important benefits: they do not rely on fossil fuels which create greenhouse gases as well as other pollution; they get their energy from the sun which is a renewable resource that is freely available to all; they reduce the additional usage of fossil fuels required to transport fuels to users premises to create heat (in the case of Solar Hot Water systems); they create energy at the point of usage, creating efficiencies in transmissions; they are generally durable systems which pay for themselves over time and then can be used after they have been amortized; they decrease the demand for fuels from volatile areas of the globe; and they decrease the need for destroying natural habitats required to extract fuels.

Over the past decade, rising greenhouse gases have been directly related to an increase in global warming. This is now established scientific fact which could have grave concerns if it continues to rise unabated. This further underlines the benefit of solar panels/systems which reduce the need to generate power with fossil fuels that contribute to this issue. The realization of the Federal, State and some Local governments that fossil fuels create both environmental as well as geopolitical issues has led to a broad set of incentives at all levels. These change on a regular basis, but one example is a current federal energy bill that provides a tax credit worth up to 30 percent of the cost of residential solar panels. The credit is capped at $2,000 but can be combined with other incentives. With or without government support, consumers have had the ability to purchase solar power systems for years. The traditional method of purchasing a system and then seeking the Federal, State and Local credits suffers from drawbacks and limitations. The initial expense is often prohibitively large, with up-front costs that are beyond the means of many consumers, even if they were able to recoup the costs over time. If consumers had the option to purchase energy generated from solar panels/systems on their premises as it was generated rather than as an up front fixed cost, this would not only benefit the consumer in terms of long term energy pricing, but would also provide the environmental and national benefits as described above.

The primary types of solar systems are electric (photovoltaic) and thermal (generally for hot water). The technology for thermal systems matured relatively quickly, and these produced (and continue to produce) the highest energy content for surface area covered by the panels. The issue with them being more widely adopted has to do with price competition with inexpensive hot water heaters and the economics of how water heaters are purchased (as noted above). The technology for photovoltaic systems continues to advance with several breakthroughs likely in the next few years as start-up companies seek to mass produce panels that do not require expensive silicon. If successful, this could revolutionize the industry. Even if these technologies take longer to develop than expected, there are several other developments which enable the creation of more efficient panels while using much less silicon. Finally, annually increasing demand is leading to the creation of additional manufacturing facilities which will likely reduce prices in the long term.

Many more Consumers would likely use locally based renewable power systems if they did not require such a relatively large upfront investment. One way to increase usage would be to enable consumers to pay for such systems based upon usage, similar to the process that most people use with their existing utility.

Generally, the purchase of energy today by consumers and small businesses takes place locally with each utility (based on local rules and regulations) setting its own rates. The local utilities' billing systems are specialized according to their requirements; these systems are generally inflexible, treating all customers of a certain type (e.g. residential vs. commercial) according to the same terms.

Utilities generally charge for energy based on Kilowatt Hours (KwH) or according to BTUs for natural gas. Each unit has a price, which is then adjusted according to delivery charges, surcharges, taxes and other fees. Based on energy usage for a given period (generally one month), the customer is then billed by the utility. This system works well for the utilities since most customers are charged similar rates throughout the service area, and billing/collections follow that specific utility's rules, which are in term based on local rules/regulations.

As renewable energy becomes a higher priority worldwide, governments at federal, state and even local levels are creating incentives for people who install renewable energy systems at their premises. These incentives can at times equal over half of the cost of the system, including installation, which then makes the power generated competitive with that offered by the conventional (fossil fuel) sources. These incentives also vary significantly between residential and business users, small and larger systems and even how a system is installed (e.g. whether it is grid-tied). They also vary frequently as government policy changes.

As at-premise renewable power becomes more popular, companies may offer it as a service (i.e. these companies will own the renewable energy systems and charge customers usage fees for the power generated from their at-premise systems). The current set-up of utilities' billing systems would not be able to efficiently handle this across areas with highly variable charging methods, regulations and incentives. The main problem with creating a system that leverages a common technology backbone for handling customers of at-premise renewable energy is that each location may differ for the following variables: Rates differing by time of day; Rates differing by period of the year; Rates differing based on usage (e.g. higher rates when usage exceeds 1000 KwH per month); Rates differing based on incentives (e.g. higher rates for power sold back to the grid through net-metering); Rates differing based on other charges. Against this complex background, this Invention provides a method and a system to sign-up customers in diverse locations and track their usage and billing according to a wide variety of variables by virtue of a unique Calendar for each customer, which integrates seamlessly into a common architecture and accounts for the usage and variables unique to at-premise renewable power systems.

These and other features, aspects and advantages of the present invention will become better understood with reference to the following description and claims.

### SUMMARY OF THE INVENTION

The present invention relates generally to systems and methods for enabling standardized billing for distributed at-premise renewable Power Systems. This is done through the creation of unique client Calendars.

According to one embodiment, a computer implemented method of billing power as it is generated at a consumer's premises, the method comprising: providing at least one at-premise renewable Power System to a consumer; providing at least one Calendar, wherein the Calendar is comprising at least one Period (a duration lasting at least one day, though generally measured in months) and each at least one Period has at least one Segment (a duration measuring a day or less); providing at least one consumer variable associated with the consumer; assigning a Calendar to the consumer; assigning at least one Rate and at least one characteristic to each said at least one Segment; determining the power generated by the at least one at-premise renewable Power System for the at least one Segment to provide the power generated; determining the usage of the at least one at-premise renewable Power System for the at least one Segment to provide usage; determining a Segment Charge on an ongoing basis according to the consumer's power generated, the usage, the customer variables, the Rate and the at least one characteristic for at least one Segment to provide a Segment Charge and summing the Segment Charges for the Period to provide a bill for a specific duration within the Period; and billing the consumer the bill.

These and other features, aspects and advantages of the present invention will become better understood with reference to the following description and claims.

### BRIEF DESCRIPTION OF THE DRAWINGS

FIG. 1 depicts the present invention;

FIG. 2 depicts the present invention; and

FIG. 3 depicts the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

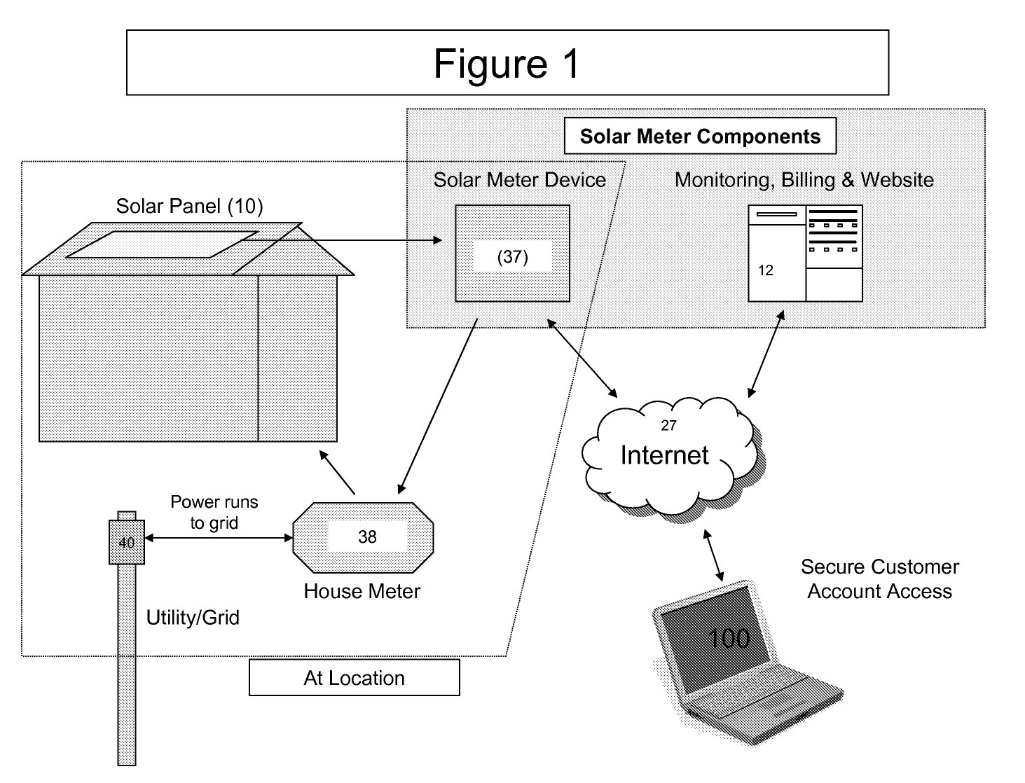

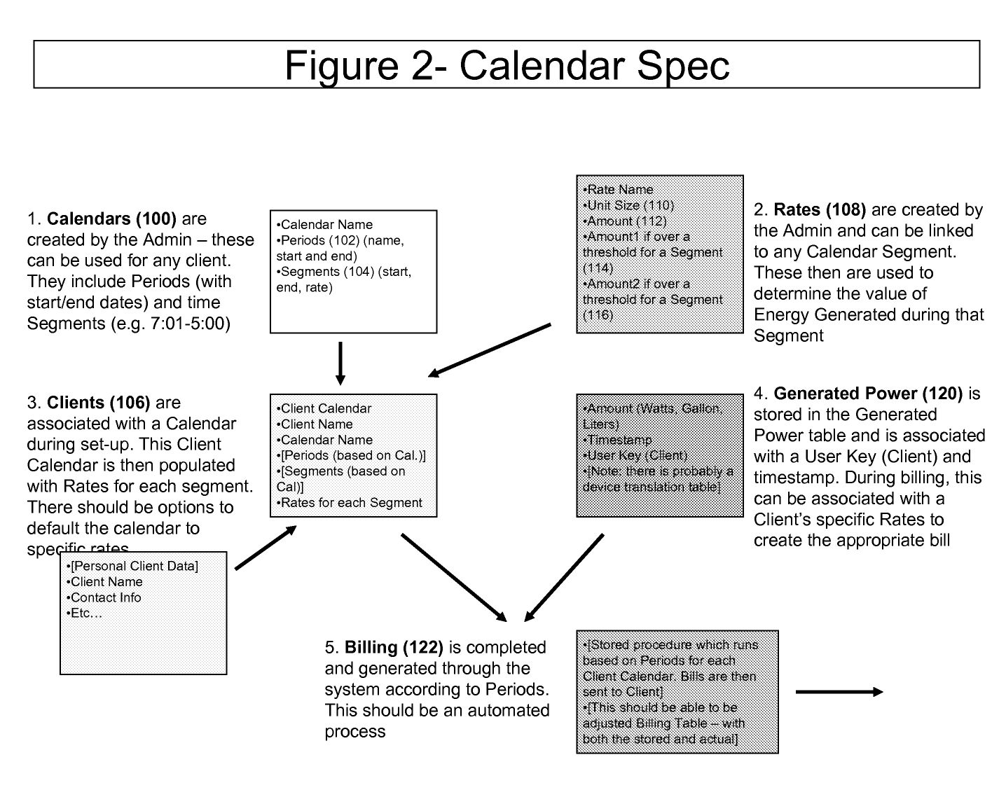

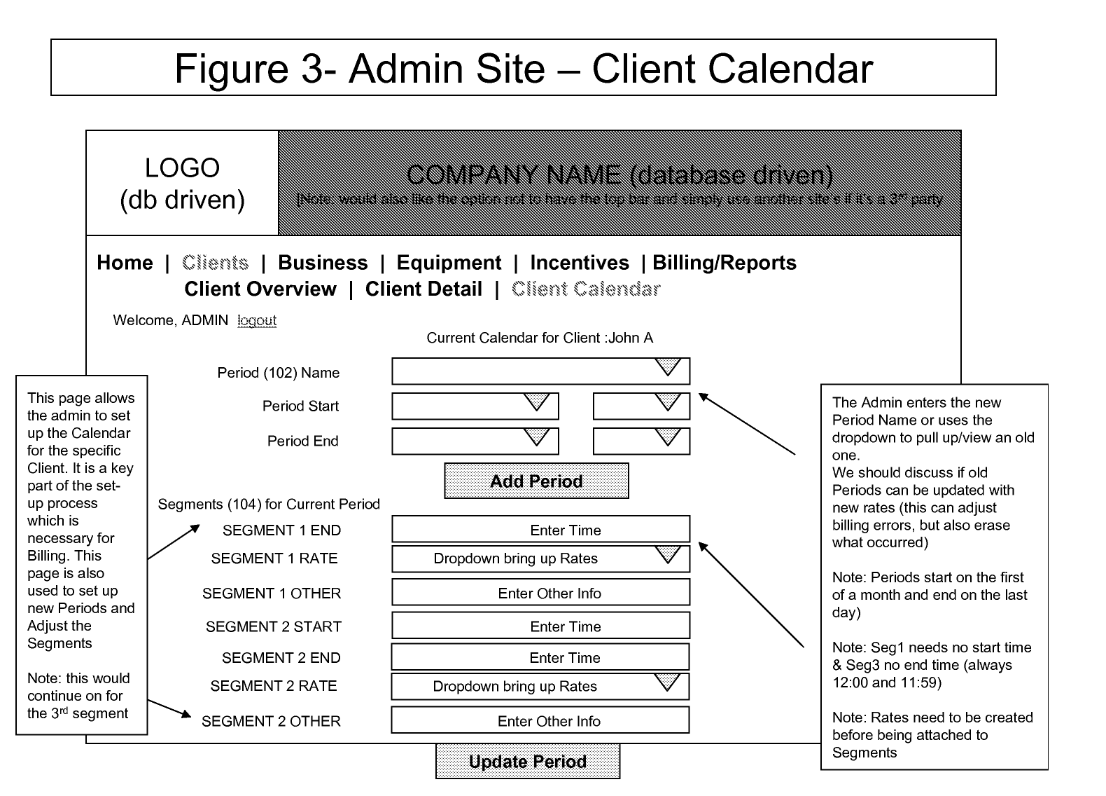

With reference to FIGS. 1-3, the present invention provides systems and methods for providing power at a consumer's premises and billing according to usage. A computer implemented method of billing power as it is generated at a consumer's premises, the method comprising: providing at least one at-premise renewable Power System (e.g. 10) to a consumer.

It should be understood the consumer may not pay an upfront cost for the system, unlike prior art systems, the system is provided at no cost and the energy generated/ usage pays for the system. This is particularly viable when the operating costs are far outweighed by the upfront cost of the system. For example, a third party owner may own the at least one at-premise renewable Power System and lease the at least one at-premise renewable Power System to the consumer. The third party owner may also own the at least one at-premise renewable Power System and lease the system to a third party financer.

The method may further comprise the steps of; providing at least one Calendar (100), wherein the Calendar is comprising at least one Period (102) and each at least one Period has at least one Segment (104); providing at least one consumer (106) variable associated with the consumer (106, the terms client and consumer are interchangeable); assigning a Calendar (100) to the consumer (106); assigning at least one Rate (108) and at least one characteristic (e.g. 110, 112, 114, 116) to each at least one Segment (104). The Rate may be further comprised of Rate characteristics, the Rate characteristics comprising energy unit charge, additional charge for peak billing systems, additional charge for tiered billing system and threshold limits. The step of assigning a Rate may be performed by a third party supply company. The method may further comprise the steps of: determining the power generated (120) by the at least one at-premise renewable Power System (e.g. 10) for the at least one Segment to provide the power generated. The term Period is intended to referred to any predetermined amount of time, typically more than one day and usually a series of months (for example a season). The term Segment is intended to refer to a predetermined amount of time that would be smaller than a Period and would generally be up to one day.

The process by which the amount of power generated by the at-premise renewable energy system (which may be KwH or gallons/liters of hot water) is allocated to the correct Period/Segment may be as follows: (i) The system/method incorporates a remote monitoring device which is connected to the at-premise renewable energy system. This remote monitoring device connects to the main software technology platform; (ii) Whenever a unit of energy (KwH or gallon/liter) is generated, the information updates the central database along with the Customer and exact time of generation; (iii) When billing (122) is run by the system (this may be a monthly process), the software matches a specific Customer's usage for the billing Period to the matching Segment Rates/Other Variables for the Calendar Period. This allows for customized billing for each Customer using the same technology infrastructure.

The method may also comprise the steps of: determining the usage of the at least one at-premise renewable Power System for the at least one Segment to provide usage; determining a Segment Charge on an ongoing basis according to the consumer's power generated, the usage, the customer variables, the Rate and the at least one characteristic for at least one Segment to provide a Segment Charge and summing the Segment Charges for the Period to provide a bill for a specific duration within the Period; and billing the consumer the Period bill.

Each customer will have its own unique Calendar. This unique Calendar ensures that the Customer can be billed according to a broad range of criteria while still having all Customers in a common system/database. For example, Customers in New York and Florida may have different incentives, different local policies for energy rates (e.g. a standard rate in New York with delivery surcharges and a tiered ‘peak’ midday rate in Florida for summer months). The at least one at-premise renewable Power System's available incentives may be selected from the group consisting of state, federal, local and equipment. With the unique Calendars, the system would be able to simply record usage for both customers, and then calculate the bills based on each Customer's unique Calendar and the associated rates and incentives. The Customer Calendar will be set up when the customer is created and maintained thereafter.

The Customer Calendar has the following main features: The Calendar is divided into Periods. Each Period has an individual name, as well as a start date and end date. New Periods can be created ahead of time (e.g. scheduled for future application to a specific customer if it is know that rates will change—for example, summer electricity pricing). Other aspects of Periods are as follows: (i) Each Period has one or more Segments. For example, in a 3 Segment Period, these would separate the day into three parts from 12:00 AM to 11:59 PM. Each Segment has a specific start and end time (Segment 1 start would always be 12:00 AM and Segment 3's end would always be 11:59 PM). Each Segment has at least one individual Rate (or price for the power generated) associated with it; (ii) Periods are always saved in the database. This enables historical billing to take place. This is an important part of the Invention since it allows for the retention of the specific values of generated power in the past.

The Calendar allows the assignment of Rates and Incentives to specific times during which power is generated. This is important since it allows the system to flexibly calculate bills based on a wide variety of factors. Without this functionality, a system with the same capabilities would be substantially more complex and expensive, making it more difficult to deliver at-premise renewable energy as a service. The factors which can be billed at the same time with unique calendars are as follows: (i) Different rates during the same day; (ii) Multiple rate changes per year; (iii) Rates varying by usage; (iv) Different incentives; and (v) Flexible application of other charges.

A unique Customer Calendar is set-up when the Customer is created. One or more Periods are assigned, along with the Segments within each Period. Then, Rates and other variables are assigned to each Segment. Specifically, the process for setting up a unique Calendar may work as follows: (1) The user of the system/method creates a Customer of an at-premise renewable energy system containing that Customer's information (address, billing information, equipment, etc.); (2) As part of the set-up, the user of the system/method then creates the unique Calendar. Separate Calendars may be created for different renewable energy systems owned/operated by the Customer in order to provide this flexible billing for the various systems; (3) The Calendar becomes part of the Customer's profile, and is then updated with Periods, Segments, Rates and Other Attributes.

After the unique Calendar is set up for a particular Customer, one or more Periods are created. These are created through the system interface according to the following attributes: (i) Start Date: This is the date when a Period begins and usually starts at the beginning of the month; (ii) End Date: This date completes the Period and also usually occurs at the end of month. The system/method may contain functionality to ensure that the Start and End Dates do not conflict with any other Start/End dates within a unique Customer Calendar; (iii) Segments: These are the durations of time during the days which make up the Periods. For example, a Period will generally start at the beginning of a month and be completed at the end of the month sometime in the future. Each Period is then divided by days which are then divided by Segments. The Segments allow parts of each day to be assigned different attributes.

The following example illustrates how a Period and Segment are set-up for a sample Customer: (i) A Client, John Smith, signs up for an at-premise renewable energy system in New York State that is maintained by a company using this Invention on Jan. 15, 2008 and is set up in the system; (ii) During set-up, a unique Client Calendar, ‘JohnSmithCalendar’ is set up; (iii) The initial Period, called Period 1, goes from Jan. 1, 2008 to Jan. 30, 2099 (this will be updated when the next Period is created, but the system/method has been designed not to have the Period run out during normal operations. An additional aspect of the invention is that an alert will notify when a Customer's last Period is about to expire); (iv) Based on the sample system configuration, Period 1 has three Segments to set up. 12:00-7:00 with NY Central Hudson Rate 1, 7:01-5:00 with NY Central Hudson Rate 2 and 5:01 to 11:59 with NY Central Hudson Rate 1. This functionality allows NY Central Hudson Rate 2 to be priced at a higher charge. Because John Smith has a unique Customer Calendar, the same system/method could be used to handle many other Customers with differing Rates/charge periods, etc.

It is envisioned the present invention may include a Calendar Wizard feature, which is a tool which is part of the Invention that is used to create the unique Customer Calendars. This allows the software user to easily create additional Calendars quickly. The Calendar Wizard may contain the following functionality: (i) Ability to use drop-down boxes to quickly select Periods and Segments; (ii) Error processing logic to ensure that a unique Client Calendar's Periods and Segments do not overlap with each other; (iii) Ability to link to Rates and Other Variables which have been set-up within the system/method which can be used by multiple Customers; and (iv) Ability to clone other Customer Calendars when these will make set-up easier.

There may also be a Period Update Wizard feature. This is an important tool which allows the company using the system to update the Periods, Segments and associated Rates and other variables for more than one Customer. Otherwise, the company would need to update each Customer Calendar individually. The Period Update Wizard allows the following functionality: (i) Updating one or more Periods for one or more Customers. In this example, Customers who share rates, incentives, etc. could have their Periods and associated variables updated to match each other. This may also include the step of remotely changing at least one of the consumer's customer variables according to the consumer's desired consumer monthly payment. In this way the or energy delivered may be set to equal a desired monthly payment. Once the consumer gets close to their allotted payment/energy delivered, an email may go out informing the consumer so that they may reduce consumption. Alternatively, the consumer may set allotted usage and the usage may be remotely controlled. This may be particularly useful for rental properties where the utilities are included. By way of example, the temperate may be set to remain at 72 during the evening in the summer and 76 during the day (to conserve resources as the consumer may generally be at work during those hours). As another example, lights may be set to shut off automatically at 9:30 am when the consumer generally goes to work. This may also be overridden by manually turning back on the lights (in this example, as obviously lights may be necessary if the consumer was home for some unexpected reason).

The Wizard feature may work by allowing the user to select one or more Customers and then changing the Period for all the Customers selected; (ii) The following example shows how this process would work for two Customers, though this could be done for any number of Customers: A Customer, Jane Adams, is an existing client of Company ABC with an at-premise PV system in a given location. Joe Brian also has an at-premise PV system in that location which is also owned by Company ABC. These Customers, as well as others in the same area experience a Rate change (which had been brought on by the local utility). Jane Adams' Customer Calendar was created on Sep. 1, 2007. The Period begins on that date and is set to continue through Sep. 30, 2100. Joe Brian's Customer Calendar was created on Dec. 1, 2007 with a Period from that date from Dec. 30, 2100. The Rate change occurs on Feb. 1, 2008. The utility also creates a peak usage surcharge for power used from 7:01-5:00 that is over 1000 kilowatt hours. The system Admin adjusts the Period Wizard Feature to create a new Period for Jane Adams, Joe Brian as well as any other selected Customers to reflect both this Rate change as well as the peak pricing. Without the unique Customer Calendar, this would not have been possible. The new Period goes from Feb. 1, 2008 to Feb. 28, 2100. All affected Customers have their current Periods adjusted to end on Jan. 31, 2008. The new Period has three Segments to set up. 12:00-7:00 with NY Rate 1, 7:01-5:00 with NY Rate 4 (the new rate with the surcharge) and 5:01 to 11:59 with NY Rate 3. The system Admin can still review the previous Periods associated with each Customer's unique Calendar and the associated Rates through the system.

Updating the Rates within a Period for one or more Customers. In this examples, the Rates can be updated for more than one Customers, who all share a similar Period in their unique Calendars.

Updating the Incentives/other variables within a Period for one or more Customers. In this examples, Incentives or other variable can be updated for more than one Customers, who all share a similar Period in their unique Calendars can be updated. This is the function whereby the unique Customer Calendar allows the bill to be calculated for each customer using one system. Based on the example used earlier, the system will run through the month of October for John Smith. It will pull up Period 2 (the Current Period) from the JohnSmithCalendar and begin to go through all Segments, determining: (i) If anything was generated; and (ii) How much to bill for each unit based on the associated Rate. After Generation is tallied for each Segment in the month and multiplied by the Rate, the bill is calculated for that client.

The method may further comprise the steps of: calculating an equivalent amount of carbon which would have been created to generate the power utilized for the at least one Period to provide a carbon deficit. Also, the method may comprise the step of offering carbon credits according to the carbon deficit. The step of calculating carbon deficit may take into account any energy generated. The Carbon credit Periods may start on the first of a month and end on the last day of a month. This may match the billing cycles.

Rates are the amounts charged for the number of units of energy generated. These can be shared across the Periods/Segments. Whenever required, new Rates will be created since the old Rates in the system will be maintained for past billing, etc. Rates have the following characteristics: (i) They have a primary amount at which energy units are charged; (ii) They have additional amounts for peak/tiered billing systems; (iii) They can have thresholds to limit billing if required.

The method may further comprise the steps of: monitoring the consumer's customer variables to provide an actual customer variable; and adjusting the consumers monthly payment according to the actual customer variable. The method may be further comprised of: providing a remote monitoring device in communication with said at least one at-premise renewable Power System; providing a computer implemented central database in communication with the remote monitoring device; and determining when a unit of energy is generated by at least one at-premise renewable Power System to provide a unit update for the Segment; communicating the unit update by the remote monitoring device to the computer implemented central database.

There may also be the step of determining the at least one at-premise renewable Power System's available incentives; adjusting the Segment Charge according to the at least one at-premise renewable poser system's available incentives. In addition to the Rates, each Segment can have specific Incentives/Other Variables associated with them. These allow for the calculation of additional charges or variability within these charges when needed. More specifically, these would include: (a) The ability to adjust the Rate for energy usage over a specified amount (e.g. in a tiered system); (b) The ability to adjust the Rate for power sold back to the grid from the renewable energy system (e.g. subsidized rates for peak Periods); (c) The ability to add surcharges; (d) The ability to place thresholds around charges which can be negotiated between the company using the system/method and the Customer; (e) The ability to account for incentives within the billing.

The at least one at-premise renewable Power System's characteristics may be selected from the group consisting of initial Power System cost, component cost, installation costs, total wattage, average sunny days per year, average prime sunlight hours per day, monthly generation estimates, current usage of electricity and estimated percentage generation for net metering. The consumer's customer characteristics are selected from the group consisting of local weather, current energy usage, desirable temperature, percentage used during sunlight hours, percentage used during peak hours, temperature zones and local utility policies on net metering, current utility costs during peak hours, current utility cost during off peak hours and client payment for system. The at least one at-premise renewable Power System may be a solar system, solar panel system, photovoltaic, thermal, wind powered, geothermal, hydropower or any other system. Also, the terms at-premises, on premises and at-premise are interchangeable and equivalent. Additionally, for those interested in heating and cooling their dwelling via renewable energy, geothermal heat pump systems that tap the constant temperature of the earth, which is around 7 to 15 degrees Celsius a few feet underground, are an option and save money over conventional natural gas and petroleum-fueled heat approaches. The term on premises renewable Power System does not include conventional natural gas and petroleum fueled heat.

The method may further comprise the steps of: monitoring the system from a remote location; and monitoring the usage from a remote location. The method may comprise the steps of: generating an alert when the customer variables are a prescribed percentage different than historical averages. The method may also comprise the steps of monitoring and storing the consumer's customer variables and usage.

It should be understood that the foregoing relates to preferred embodiments of the invention and that modifications may be made without departing from the spirit and scope of the invention as set forth in the following claims.

I claim:

1. A computer implemented method of enabling standardized billing for an at-premise renewable Power System as it is generated at a consumer's premises, said method comprising:
providing at least one at-premise renewable Power System to a consumer;
providing at least one Calendar, wherein said Calendar is comprising at least one period and each at least one period has at least one Segment;
providing at least one consumer variable associated with said consumer;
assigning a unique Calendar to said consumer;
assigning at least one Rate and at least one characteristic to each said at least one Segment;
determining the power generated by said at least one at-premise renewable Power System for said at least one Segment to provide the power generated;
determining the usage of said at least one at-premise renewable Power System for said at least one Segment to provide usage;
determining a Segment Charge on an ongoing basis according to said consumer's power generated, said usage, said customer variables, said Rate and said at least one characteristic for at least one Segment to provide a Segment Charge and summing said Segment Charges for said Period to provide a bill for a specific duration within said Period; and
billing said consumer said bill.

2. A method as in claim 1, further comprising the step of:
calculating an equivalent amount of carbon which would have been created to generate the power utilized for said at least one Period to provide a carbon deficit.

3. A method as in claim 2, further comprising the step of:
offering to said consumer an offer for carbon credits according to said carbon deficit.

4. A method as in claim 1, further comprising the step of:
monitoring said consumer's customer variables to provide an actual customer variable; and
adjusting said consumers monthly payment according to said actual customer variable.

5. A method as in claim 1, further comprising the steps of:
wherein said step of assigning a Rate is performed by a third party supply company.

6. A method as in claim 1, further comprising the step of:
determining said at least one at-premise renewable Power System's available incentives;
adjusting said Segment Charge according to said at least one at-premise renewable poser system's available incentives.

7. A method as in claim 1, wherein said at least one at-premise renewable Power System's characteristics are selected from the group consisting of initial Power System cost, component cost, installation costs, total wattage, average sunny days per year, average prime sunlight hours per day, monthly generation estimates, current usage of electricity and estimated percentage generation for net metering.

8. A method as in claim 1, wherein said consumer's customer characteristics are selected from the group consisting of local weather, current energy usage, desirable temperature, percentage used during sunlight hours, percentage used during peak hours, temperature zones and local utility policies on net metering, current utility costs during peak hours, current utility cost during off peak hours and client payment for system.

9. A method as in claim 1, wherein said at least one at-premise renewable Power System is selected from the group consisting of solar system, solar panel system, photovoltaic, thermal, wind powered, geothermal, hydropower.

10. A method as in claim 1, wherein said at least one at-premise renewable Power System's available incentives are selected from the group consisting of state, federal, local and equipment.

11. A method as in claim 1, further comprising the step of:
monitoring said system from a remote location.

12. A method as in claim 1, further comprising the step of:
Monitoring said usage from a remote location.

13. A method as in claim 1, further comprising the step of:
Generating an alert when said customer variables are a prescribed percentage different than historical averages.

14. A method as in claim 1, further comprising the step of:
monitoring and storing said consumer's customer variables and said usage.

15. A method as in claim 1, further comprising the step of:
remotely changing at least one of said consumer's customer variables according to said consumer's desired consumer monthly payment.

16. A method as in claim 1, further comprising at least one third party owner, wherein said third party owner owns said at least one at-premise renewable Power System and leases said at least one at-premise renewable Power System to said consumer.

17. A method as in claim 1, further comprising at least one third party owner, wherein said third party owner owns said at least one at-premise renewable Power System and leases said at least one at-premise renewable Power System to a third party financer.

18. A method as in claim 1, further comprising the step of:
selling energy from said at least one at-premise renewable Power System to a recipient;
receiving income from said recipient;
adjusting said customer variables including usage and
adjusting said consumers monthly payment.

19. A method as in claim 1, further comprising the step of:
Accepting an updated Period for at least one customer.

20. A method as in claim 1, further comprising the steps of:
grouping at least two customers to provide a group of customers;
accepting at least one of an updated Period, an updated customer variable and an updated Segment Charge for said group of customers.

21. A method as in claim 1, further comprising the steps of:
checking said at least one Period to ensure that a first at least one period does not overlap with a second at least one Period.

22. A method as in claim 1, wherein said rate is further comprised of rate characteristics, said rate characteristics comprising energy unit charge, additional charge for peak billing systems, additional charge for tiered billing system and threshold limits.

23. A method as in claim 1, further comprising:
providing a remote monitoring device in communication with said at least one at-premise renewable Power System;
providing a computer implemented central database in communication with said remote monitoring device; and
determining when a unit of energy is generated by said at least one at-premise renewable Power System to provide a unit update for said Segment;
communicating said unit update by said remote monitoring device to said computer implemented central database.
